(19) United States
(12) Patent Application Publication
(10) Pub. No.: US 2011/0210530 A1
(43) Pub. Date: Sep. 1, 2011

(54) Tow hitch

(76) Inventors: Jeffrey D. Hancock, Uintah, UT (US); Christopher N. Schenck, Uintah, UT (US)

(21) Appl. No.: 12/660,509

(22) Filed: Mar. 1, 2010

(51) Int. Cl. B60D 1/01

(52) U.S. Cl. 280/506

(57) ABSTRACT

A tow hitch for connecting a towing vehicle to a towed vehicle or other towed object including a receiving member to receive an insert member. The insert member has multiple connectors for selected use in securing a towed vehicle or other towed object, and a wedge secured to the insert member so that the wedge is positioned on a top surface of the insert member and between the insert member and the receiving member and is held against working it's cog out from between the insert and receiving member during us.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

### Field of the Invention

This invention relates to tow hitches for vehicles. Many types of hitches for use between a towing vehicle and a towed vehicle have been developed in the past. At the present time the most common type hitch is believed to be a system, involving a receiver member that is secured to the towing vehicle. One end of an insert member slides into the receiver member and is secured in place by a locking pin that extends through both the receiving and the insert member. An opposite end has a connector member thereon to which a towed vehicle can be coupled. The towing vehicle may be an automobile, a pick-up truck, a larger truck, or a smaller vehicle such as an all-terrain vehicle (ATV), or even a snowmobile, or a large tractor or a small garden tractor. Virtually any small vehicle can be used to tow a trailer or other suitable towable vehicle.

The connector member attached to the opposite end of the insert member, for use in towing a vehicle often is a ball hitch and/or an attachable bar with a hole through which a clevis pin can be inserted to secure a bifurcated clevis on the tongue of the towed vehicle. An attachment to enable a chain to be connected between the towing vehicle and the towed vehicle may also be used or included.

The receiver member provided for towing vehicles is frequently produced by different manufacturers than are the insert members to which the towed vehicle is attached. Consequently it is not uncommon that the receiving members have receiving openings that are one size while the insert members, produced by different manufacturers may be of a considerably different smaller size. The inserts are made to insure that they will fit into any receiver member that may be on a vehicle to be used as a towing vehicle. With the difference in size between the receiver member and the insert member, it has been found that the hitch assembly often times is sloppy and noisy. The noise results from the insert member bouncing up and down inside the receiver member as the vehicle travels, and particularly as the vehicle travels over rough terrain. The noise created is annoying and distracting to people traveling in the towing vehicle. In addition, the movement of the insert member in the receiving member can also cause excess wear between the parts.

### BRIEF SUMMARY OF THE INVENTION

### Objects of the Invention

Principal objects of the present invention are to provide an insert member to be used with receiving members on towing vehicles, with the insert member having a variety of connecting members for attachment of towed vehicles, or other objects such that one insert member will accommodate the attachment of a variety of hook-ups between towing and towed vehicles or objects.

Another object is to provide a wedge assembly that includes means to stabilize the insert member inside a receiver so that the insert member does not bounce within the receiving member, thereby eliminating or greatly reducing noise and wear that would otherwise occur as a result of a sloppy fit between the receiver and the insert member.

### Features of the Invention

Principal features of the invention include an insert member that has an exterior shape corresponding to the interior shape of a receiver into which the insert member is to be positioned. The receiver is mounted on a towing vehicle with an open end into which one end of the insert member is to be positioned. The receiver member is preferably of a square configuration, although it will be apparent that other shapes can be used. The insert member is elongate and has a cross-sectional shape corresponding to the interior cross-sectional shape of the receiver member and sized to allow one end of the insert member to be pushed into the open end of the receiver member. Holes in opposite sides of the receiver member are aligned with a hole, or aligned holes, through opposite sides of the insert member so that a locking pin can be inserted through a first side wall of the receiver member, through the insert member, and through an opposite side wall of the insert member. A spring clip inserted through a hole in the inserted end of the locking pin holds the locking pin in place and holds the insert member in position, extending into the receiver member.

The opposite end of the insert member projects from the receiving member to support connector members for releasably attaching a towed vehicle or other objects. The connector members include a ball mounted on top of a rearwardly projecting upper plate that extends from an upwardly extending support plate on the opposite end of the insert member. A lower plate that extends parallel to the support plate for the ball includes a hole therethrough and an arm that extends downwardly from the support plate for the ball to the upright support plate at a location just above the connection between the upright support plate and the lower projecting plate. A hole is provided through the upwardly extending support plate and a stem extending from a wedge is inserted through the hole to be held in place by one or more collar(s) on the stem.

The wedge has a flat bottom surface that will rest on the top surface of the insert member and an inclined top surface. The wedge has a thin leading edge and the inclined copper surface that may be curved or straight as it extends to a thicker rear edge from which the stem extends. The wedge, including the stem, is made from a durable plastic type material that will fit between the interior top of the receiving member and the upper surface of the insert member.

The stem, passing through the hole in the upwardly extending plate, holds the wedge in position to extend between the receiving and insert members and to prevent movement of the insert member in the receiving member during travel of the towing and towed vehicles.

Additional objects and features of the invention will become apparent from the following drawings and detailed description.

### BRIEF DESCRIPTION OF THE FIGURES OF THE INVENTION

In the Drawings

FIG. 1 an exploded view showing a towing vehicle with a receiver member attached thereto and a insert member with attached components, in line to be positioned in the insert member;

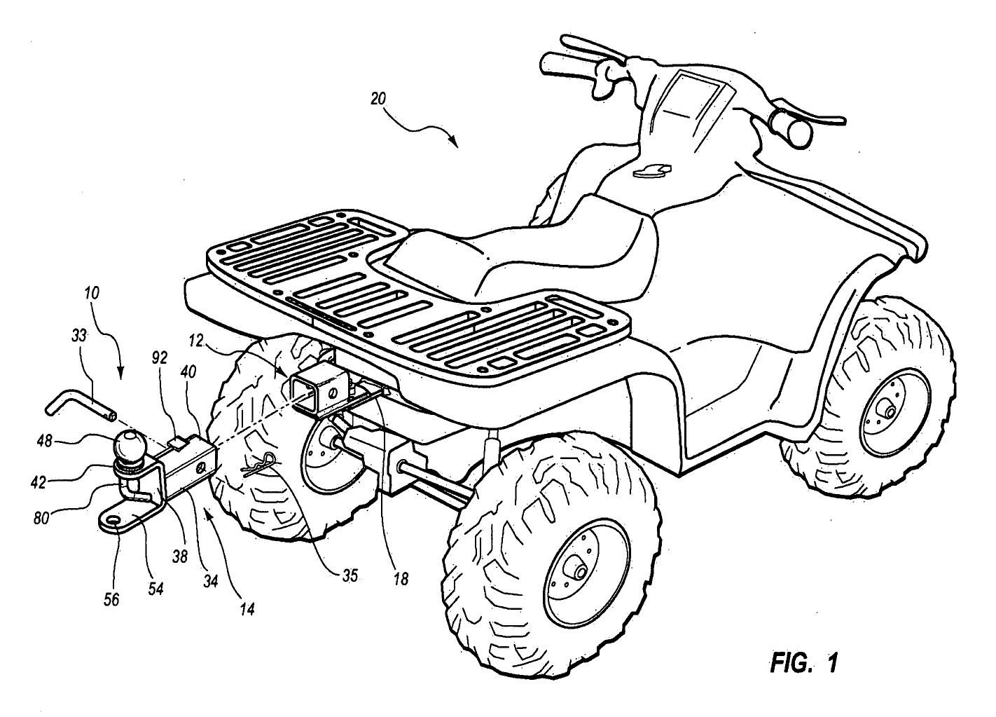

FIG. 2, an exploded perspective view of a tow hitch of the invention, showing an insert receiver fragmentarily and a clevis on the end of a tow bar of a towed vehicle; and

FIG. 3, a perspective view taken from the side opposite the view shown in FIG. 1 of the insert member and attached components.

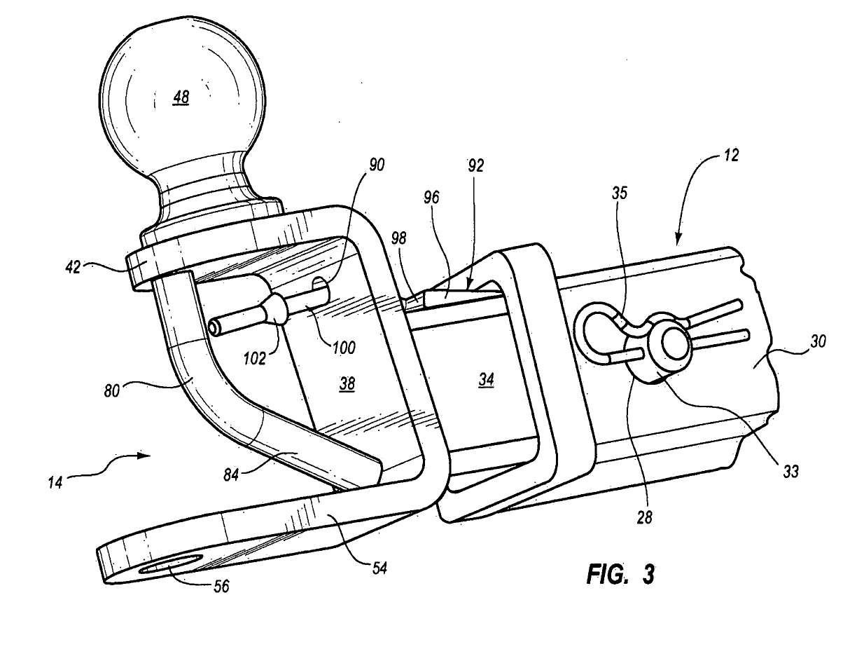

### DETAILED DESCRIPTION

Referring Now to the Drawings

In the illustrated preferred embodiment a tow hitch shown generally at 10 includes a receiver member shown generally at 12 and an elongate insert member, shown generally at 14.

The receiver member 12 is formed of a sleeve 16 having a square cross-sectional configuration. Sleeve 16 is bolted, welded, or otherwise affixed to a frame member 18 of the towing vehicle 10. Receiver member 12 has an inlet opening 22 at a receiving end 24, to receive one end of the elongate insert member 14, as will be further explained. A pair of holes 28 are provided through opposite side walls 30 of the sleeve 16.

The elongate insert member 14 has a square cross-sectional outside configuration that is just slightly smaller than the inlet opening 22. Insert member 14 may be solid, or it may have a central bore (not shown) extending therethrough. A hole 32 may extend through the body, or such hole may comprise a pair of holes extending through sidewalls 34 of the insert member 14, if the insert member has a central bore.

As previously noted, the end 26 of insert member 14 is adapted to telescope into the sleeve 16. An opposite end 36 of the insert member 14 has a plate 38 covering the end and extending above the top surface 40.

Plate 38 has a rearwardly extending flange 42, with a hitch ball 48 fixed to a top surface 50 thereof.

Another flange 54 extends rearwardly from plate 38 and parallel to plate 42. A hole 56 is provided through flange 54 so that holes 58 through parallel extensions 60 of a clevis 62 can straddle flange 54 until the holes 56 and 58 align. A locking pin 61 is inserted through the aligned holes and a spring clip 64 is inserted through a hole 66 through the inserted end of locking pin 62.

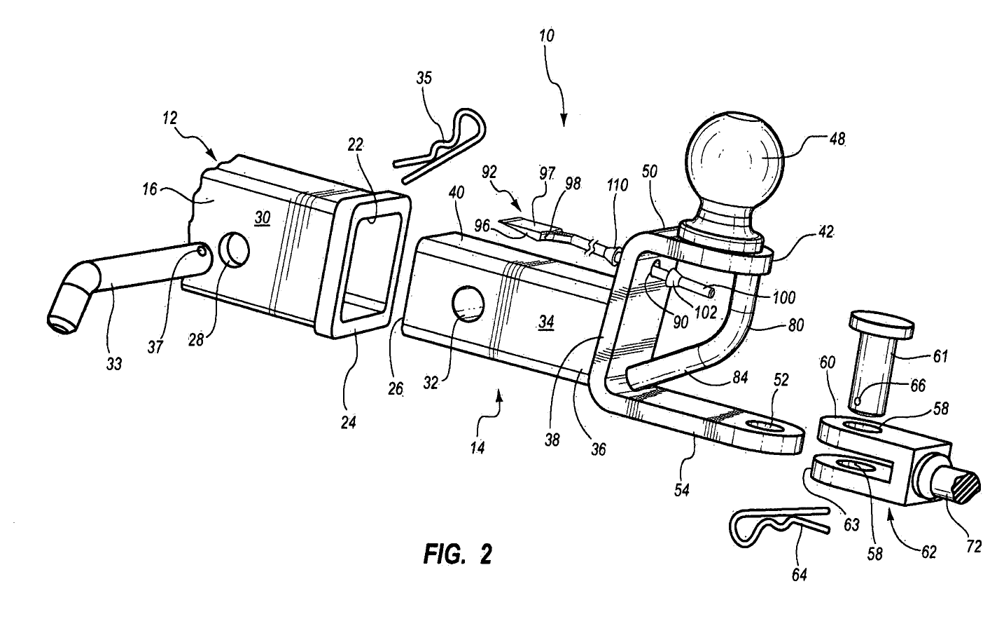

Clevis 62 is attached to the end 70 of a tow bar 72, shown fragmentarily, FIG. 2, that is connected to a towing vehicle, not shown.

A curved bar 80 has a top end fixed to the bottom 82 of plate 42. A bottom end 84 of bar 80. The curved bar provides a bar around which a chain (not shown) can be wrapped to be used in towing a vehicle or even objects, such as loaded pallets, tree trunks, etc. The bar 80 also serves as a securement device for one end of a safety chain, the other end of which is attached to a towed vehicle, not shown.

A hole 90 is provided through plate 38 at a location above the top surface 40 of insert 14 and below the plate 42.

A wedge 92, has a thin forward edge 94, and a flat bottom surface 96 that will rest on the top surface 42 of insert member 14. A rear edge 98 of the wedge 92 is thicker than the forward edge 94.

A stem 108 projects from the rear edge 94 of the wedge and is sized to fit through the hole 90. A flared collar 102 is formed on stem 100 such that the collar will collapse to allow the stem to be pushed through hole 90, but will flare to prevent unintended return of the collar 102 back through hole 90. This secures the stem and wedge in position for the wedge to be positioned between the insert member and the receiving member.

Another oppositely flared collar 110 on stem 100 is flared to prevent continued insertion of the stem through hole 90.

After insertion of the wedge between the top surface 40 of the insert member 14 and the inside top surface of the receiving member if the wedge tends to be pushed out of the inserted position the stem moves through the hole 90 until the collar 16 engages plate 38. The stem 100 has sufficient rigidity to hold the wedge in place.

Although a preferred embodiment of our invention has been herein described, it is to be understood that the present disclosure is by way of example and that variations are possible without departing from the subject matter coming within the scope of the following claims, which subject matter we regard as our invention.

We claim:

1. A tow hitch comprising
a receiver member adapted to be connected to a towing vehicle and having an open end;
an insert member having one end to fit into said open end of said receiver member;
a plate fixed to the other end of said insert member, said plate extending upwardly above a top surface of said insert member;
an upper flange extending rearwardly from the top of said plate;
a hitch ball fixed to and projecting upwardly from said upper flange;
a wedge having a thin leading edge, a thicker trailing edge, a bottom surface to rest on the top of said insert member; and
means securing the wedge to the insert member.

2. A tow hitch as in claim 1, further including
a lower flange extending from a lower end of the plate fixed to the other end of the insert member and extending rearwardly thereof; and
a hole through said lower flange to receive a pin securing a clevis.

3. A tow hitch as in claim 2, further including
a curved bar interconnecting the upper and lower flanges to form a chain connection.

4. A tow hitch as in claim 1, wherein the means securing the wedge to the insert member comprises
a hole through the plate fixed to the end of the insert member, said hole being positioned above the level of the top of said insert member; and
a stem projecting from the rear edge of the wedge and through said hole and a first flared collar on said stem, said collar being flared to pass through said hole through said plate but to prevent unintended withdrawal of said stem through said plate.

5. A tow hitch as in claim 4, further including
a second collar on the stem, spaced from said first flared collar in the direction of the wedge, said second collar preventing further passage of said stem through said hole through the plate.
